(19) United States
(12) Patent Application Publication
(10) Pub. No.: US 2014/0376550 A1
(43) Pub. Date: Dec. 25, 2014

(54) METHOD AND SYSTEM FOR UNIFORM GATEWAY ACCESS IN A VIRTUALIZED LAYER-2 NETWORK DOMAIN

(71) Applicant: VMware, Inc., Palo Alto, CA (US)

(72) Inventors: Andre Khan, Palo Alto, CA (US); Ganesan Chandrashekhar, Palo Alto, CA (US); Serge Maskalik, Palo Alto, CA (US); Rudra Rugge, Palo Alto, CA (US); Stephane Sezer, Palo Alto, CA (US)

(21) Appl. No.: 13/925,706

(22) Filed: Jun. 24, 2013

(51) Int. Cl. H04L 12/741; H04L 12/721

(52) U.S. Cl. CPC H04L 45/74; H04L 45/66
USPC 370/392

(57) ABSTRACT

The disclosure herein describes a system, which provides uniform access to a gateway in an extended virtualized layer-2 network. During operation, the system identifies a media access control (MAC) address, which is associated with a respective gateway in the extended virtualized layer-2 network, in a layer-2 header of a data frame. This MAC address is specific to the extended virtualized layer-2 network (e.g., for a different extended virtualized layer-2 network, a different MAC address is associated with a respective gateway). The system modifies the layer-2 header by swapping the MAC address with another MAC address, which uniquely identifies a gateway in the extended virtualized layer-2 network, in the layer-2 header and forwards the frame with the modified header to the gateway.

### BACKGROUND

The exponential growth of the Internet has made it a ubiquitous delivery medium for a variety of applications. Such applications have in turn brought with them an increasing demand for bandwidth. As a result, service providers race to build larger and faster data centers with versatile capabilities. Meanwhile, advances in virtualization technologies have made it possible to implement a large number of virtual machines (VMs) in a data center. These virtual machines can essentially operate as physical hosts and perform a variety of functions such as Web or database servers. Because virtual machines are implemented in software, they can freely migrate to various locations. This capability allows service providers to partition and isolate physical resources (e.g., computing power and network capacity) according to customer needs, and to allocate such resources dynamically.

While virtualization brings unprecedented flexibility to service providers, the conventional layer-2 network architecture, however, tends to be rigid and cannot readily accommodate the dynamic nature of virtual machines. For example, in conventional data center architecture, hosts are often inter-connected by one or more layer-2 (e.g., Ethernet) switches to form a layer-2 broadcast domain. The physical reach of a layer-2 broadcast domain is limited by the scaling constraints of a flat network and the transmission medium. As a result, different data centers are typically associated with different layer-2 broadcast domains, and multiple layer-2 broadcast domains could exist within a single data center. Furthermore, the underlying physical network is limited to approximately four thousand layer-2 domains, which must be shared among a large number of tenants of the data center. For a virtual machine in one data center to communicate with a virtual machine or a storage device in another segment within the data center or in another data center, such communication would need to be carried over upper layer (e.g., layer-3 or Internet Protocol (IP)) networks. That is, the packets between the source and destination have to be processed and forwarded by layer-3 devices (e.g., IP routers), since the source and destination belong to different layer-2 broadcast domains. While this architecture has benefits, flat layer-2 processing has its advantages. In fact, it would be desirable to exploit the advantages of both layer-3 and layer-2 models and processing capabilities in the network.

One technique to solve the problems described above is to implement an extended virtualized layer-2 network, such as a Virtual Extensible Local Area Network (VXLAN), which spans across an upper-layer network (e.g., an IP network). VXLAN is a standard network virtualization technology managed by the Internet Engineering Task Force (IETF), and works by creating a logical layer-2 network that is overlaid above a layer-3 IP network. Ethernet packets generated by virtual machines are encapsulated in an IP header before they are transported to a remote data center where the IP header is removed and the original Ethernet packet is delivered to the destination. The IP encapsulation mechanism allows a logical layer-2 broadcast domain to be extended to an arbitrary number of remote locations, and allows different data centers or different sections of the same data center (and hence the virtual machines and devices therein) to be in the same layer-2 broadcast domain. The VXLAN function typically resides within a host's virtualization software (e.g., a hypervisor), and works in conjunction with the hypervisor's virtual switch. More details of VXLAN can be found in IETF draft “VXLAN: A Framework for Overlaying Virtualized Layer 2 Networks over Layer 3 Networks,” available at https://tools.ietf.org/html/draft-mahalingam-dutt-dcops-vxlan-02, which is incorporated by reference here. Other such extended virtualized layer-2 network can be implemented using Stateless Transport Tunnels (STT), Multi-Protocol Label Switching (MPLS), and Generic Routing Encapsulation (GRE).

As Internet traffic is becoming more diverse, the evolution of virtual computing has placed additional requirements on the network. For example, as the locations of virtual machines become more mobile and dynamic, it is often desirable that the network infrastructure support the location changes of the virtual machines (can be referred to virtual machine migration). Existing extended virtualized layer-2 network implementations, however, cannot easily accommodate virtual machine migration across upper-layer boundaries. This is because a respective layer-2 segment of an extended virtualized layer-2 network is equipped with a separate physical or virtual default gateway for traffic destined to outside of the extended virtualized layer-2 network. When a virtual machine migrates from one layer-2 segment to another within the extended virtualized layer-2 network, the virtual machine becomes associated with a different default gateway and, undesirably, aware of the migration; or can remain associated with the existing default gateway, leading to inefficient bandwidth usage and higher latency for traffic.

### SUMMARY

The disclosure herein describes a system, which provides uniform access to a gateway in an extended virtualized layer-2 network. During operation, the system identifies a media access control (MAC) address, which is associated with a respective gateway in the extended virtualized layer-2 network, in a layer-2 header of a data frame. This MAC address is specific to the extended virtualized layer-2 network (e.g., for a different extended virtualized layer-2 network, a different MAC address is associated with a respective gateway). The system modifies the layer-2 header by swapping the MAC address with another MAC address, which uniquely identifies a gateway in the extended virtualized layer-2 network, in the layer-2 header and forwards the frame with the modified header to the gateway.

This extended virtualized layer-2 network can be a Virtual Extensible Local Area Network (VXLAN). A respective gateway in the extended virtualized layer-2 network is also associated with an Internet Protocol (IP) address corresponding to the MAC address associated with the gateway. The system can maintain a mapping between the MAC address and the IP address. In some embodiments, this mapping is maintained by a virtual machine, which retains the mapping during a virtual machine migration. In response to the migration of the virtual machine, the system modifies the layer-2 header by swapping the MAC address with a different MAC address, which uniquely identifies a different gateway in the extended virtualized layer-2 network and forwards the frame with the modified header to this different gateway.

Additionally, the system can identify an address resolution query (e.g., an Address Resolution Protocol (ARP) query) for the IP address from a virtual machine running on a virtualization software. In response, the virtualization software is precluded from forwarding the ARP query to a gateway associated with the IP address and locally generates an ARP response indicating a correspondence between the MAC address and the IP address, and provides the generated ARP response to the virtual machine. If the system identifies an ARP query for the IP address from a different virtual machine belonging to a different extended virtualized layer-2 network, the virtualization software generates an ARP response indicating a correspondence between the IP address and a different MAC address associated with the different extended virtualized layer-2 network. The system then provides the generated ARP response to the other virtual machine.

### BRIEF DESCRIPTION OF FIGURES

FIG. 1A illustrates exemplary extended virtualized layer-2 networks with uniform gateway access for a virtual machine.

FIG. 1B illustrates virtual machine migration in extended virtualized layer-2 networks with uniform gateway access in conjunction with the example in FIG. 1A.

FIG. 2 presents a time-space diagram illustrating an exemplary communication process of facilitating uniform gateway access.

FIG. 3A illustrates an exemplary format for an Address Resolution Protocol (ARP) query and its response frames for facilitating uniform gateway access.

FIG. 3B illustrates an exemplary format for a conventional layer-2 frame destined to a gateway and its modified header for facilitating uniform gateway access.

FIG. 4 presents a flow chart illustrating an exemplary process of a gateway module intercepting and responding to an ARP request for facilitating uniform gateway access.

FIG. 5A presents a flow chart illustrating an exemplary process of a gateway module swapping media access control (MAC) address of a frame from a virtual machine to a gateway.

FIG. 5B presents a flow chart illustrating an exemplary process of a gateway module swapping MAC address of a frame to a virtual machine from a gateway.

FIG. 6 illustrates an exemplary computing system with uniform gateway access support.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

Embodiments of the system disclosed herein solve the problem of facilitating a migrating virtual machine uniform access to a gateway in an extended virtualized layer-2 network by allocating the same anycast IP address to a respective gateway in a respective layer-2 segment of the extended virtualized layer-2 network. In an extended virtualized layer-2 network, such as a virtual extensible local area network (VXLAN), a respective layer-2 segment includes a gateway. The gateway supports upper-layer communication and allows a respective virtual machine to communicate with entities outside of the VXLAN or the layer-2 segment to which the virtual machine belongs. The virtual machine is usually configured with the gateway as the default gateway. An extended virtualized layer-2 network can also be implemented using Stateless Transport Tunnels (STT), Multi-Protocol Label Switching (MPLS), and/or Generic Routing Encapsulation (GRE). The term “extended virtualized layer-2 network” refers to any virtualized layer-2 network spanning one or more physical layer-2 segments via an upper-layer network.

However, if the virtual machine migrates to another layer-2 segment in the VXLAN, the gateway in the other layer-2 segment become the default gateway for the virtual machine. This other gateway can have a different IP and MAC address. The term “MAC address” and “IP address” are used in a generic sense and can refer to a group of bits that can identify a device in layer-2 and layer-3 networks, respectively (i.e., layer-2 and layer-3 identifiers, respectively). “MAC address” and “IP address” should not be interpreted as limiting embodiments of the present invention to Ethernet and IP, respectively. Consequently, the virtual machine needs to update its gateway information accordingly, which compromises the obliviousness of the virtual machine migration. That is, it is desirable for migrations of a virtual machine to be transparent with respect to the virtual machine. On the other hand, if the virtual machine communicates to entities outside of the layer-2 network without changing the gateway, then a respective data packet associated with the communication needs to be forwarded via an upper-layer network to the gateway of the other layer-2 segment. Such additional data packet forwarding leads to inefficient bandwidth utilization, increases latency, and adds additional burden to the VXLAN.

To solve this problem, a respective gateway in the VXLAN is allocated with the same anycast IP address. A respective virtual machine in the VXLAN is configured with this IP address as the default gateway IP address. As a result, a respective virtual machine can uniformly access any gateway using this address from any layer-2 segment of the VXLAN. Furthermore, a respective gateway can be associated with a uniform MAC address (i.e., a virtualized MAC address which remains uniform for all gateways within the VXLAN). Consequently, when virtual machine sends an ARP request for the anycast IP address, the virtual machine receives a response with the uniform MAC address.

Whenever the virtual machine requires sending a packet outside of the VXLAN, the virtual machine uses the uniform MAC address to forward the packet to the gateway. The virtualization software, such as a hypervisor, of the virtual machine swaps the uniform MAC address with the gateway MAC address of a gateway (i.e., a MAC address which uniquely identifies the gateway) in the corresponding layer-2 segment. This gateway MAC address allows the packet to reach the gateway via layer-2 forwarding. When the virtual machine migrates to another layer-2 segment and becomes associated with another virtualization software instance, the virtual machine uses the same uniform MAC address to communicate with the gateway of this other layer-2 segment. The other virtualization software swaps the uniform MAC address with the gateway MAC address of the other gateway. In this way, the virtual machine not only can uniformly access a gateway in an extended virtualized layer-2 network even after a migration, but also can dynamically select the corresponding gateway in a layer-2 segment.

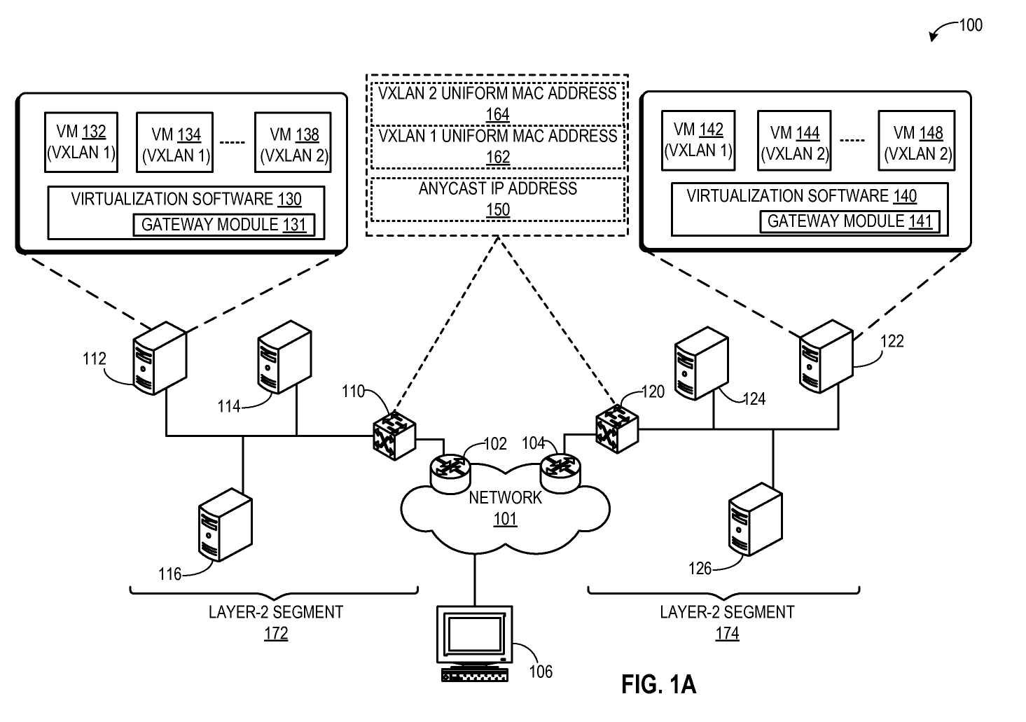

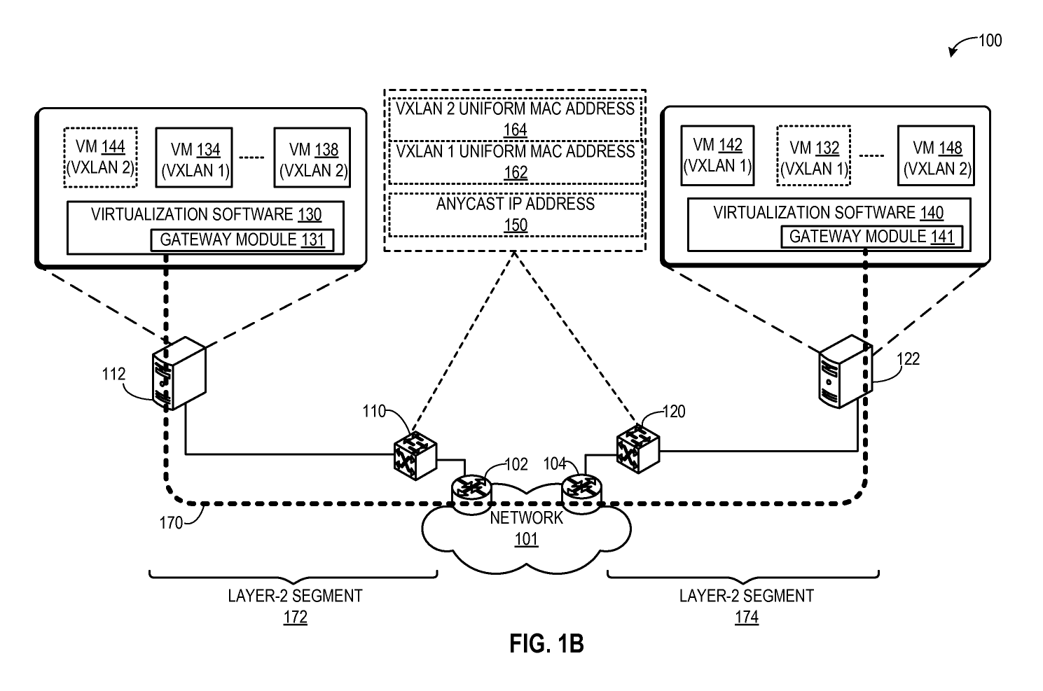

FIG. 1A illustrates exemplary extended virtualized layer-2 networks with uniform gateway access for a virtual machine. A data center environment 100 includes two extended virtualized layer-2 networks, VXLAN 1 and VXLAN 2, which can each be associated with a respective tenant (i.e., customer). VXLAN 1 and VXLAN 2 span across upper-layer network 101 and include layer-2 segments 172 and 174. Layer-2 segment 172 includes a number of host machines 112, 114, and 116, and a gateway 110. Layer-2 segment 174 includes a number of host machines 122, 124, and 126, and a gateway 120. Gateways 110 and 120 are coupled to layer-3 routers 102 and 104, respectively, and facilitate communication to outside of a respective VXLAN.

A respective host machine can host a plurality of virtual machines running on virtualization software. For example, host machine 112 and 122 run virtualization software 130 and 140, respectively. In some embodiments, virtualization software 130 and 140 are hypervisors. Virtualization software 130 and 140 can include a virtual switch via which a respective virtual machine sends packets. A number of virtual machines 132, 134, and 138 run on virtualization software 130, and a number of virtual machines 142, 144, and 148 run on virtualization software 140. In this example, virtual machines 132, 134, and 142 belong to VXLAN 1 and virtual machines 138, 144, and 148 belong to VXLAN 2. In some embodiments, data center environment 100 can include an administrator device 106, which allows a network administrator to configure a respective virtual machine (e.g., for configuring a default gateway). Virtualization software 130 and 140 includes gateway modules 131 and 141, respectively, which facilitates uniform access to gateways 110 and 120 in VXLAN 1 and VXLAN 2, respectively.

In this example, gateways 110 and 120 are associated with the same anycast IP address 150. In some embodiments, an IP address corresponds to an IP sub-network (subnet) associated with a tenant. A respective virtual machine is configured with IP address 150 as the default gateway IP address, and can uniformly access gateways 110 and 120 using IP address 150 from both layer-2 segments 172 and 174 in VXLAN 1 and VXLAN 2. Gateways 110 and 120 serve both VXLAN 1 and VXLAN 2. Hence, gateways 110 and 120 have separate uniform MAC addresses for VXLAN 1 and VXLAN 2 for uniform layer-2 access. Gateways 110 and 120 are associated with a MAC address 162, which remains uniform within VXLAN 1, and with a MAC address 164, which remains uniform within VXLAN 2. However, gateways 110 and 120 can have their own gateway MAC addresses which allow layer-2 frames to be forwarded to gateways 110 and 120.

During operation, virtual machine 132 generates a packet which is addressed to a destination outside of VXLAN 1 (i.e., requires communication outside of VXLAN 1). The term “packet” refers to a group of bits that can be transported together across a network. “Packet” should not be interpreted as limiting embodiments of the present invention to any specific networking layer. “Packet” can be replaced by other terminologies referring to a group of bits, such as “frame,” “message,” “cell,” or “datagram.” If virtual machine 132 does not know the MAC address corresponding to IP address 150, virtual machine 132 sends an ARP request for IP address 150. The term “MAC address” is used in a generic sense and can refer to any layer-2 network identifier. Similarly, the term “ARP” is used in a generic sense and can refer to a set of operations which obtain a layer-3 identifier based on a corresponding layer-2 identifier. “ARP” can be replaced by other terminologies referring to a set of operations associated with identifier resolution, such as Neighbor Discovery Protocol (NDP). Because virtual machine 132 runs on virtualization software 130, virtual machine 132 provides the ARP request to virtualization software 130 for sending outside of host 112. Gateway module 131 in virtualization software 130 intercepts the ARP request and detects that the ARP request is for anycast IP address 150.

Consequently, gateway module 131 precludes virtualization software 130 from sending the ARP request to gateway 110. Instead, gateway module 131 identifies that virtual machine 132 belongs to VXLAN 1 (i.e., identifies the tenant of virtual machine 132). Gateway module 131 then obtains uniform MAC address 162 associated with VXLAN 1, generates an ARP response comprising MAC address 162 as the MAC address corresponding to IP address 150, and provides the ARP response to virtual machine 132. In some embodiments, gateway module 131 allows the ARP query to reach gateway 110, which responds by sending an ARP response comprising the gateway MAC address of gateway 110. Because this gateway MAC address is not uniform, gateway module 131 intercepts the ARP response from gateway 110, modifies the ARP response by swapping the gateway MAC address with uniform MAC address 162, and provides the modified ARP response to virtual machine 132. Hence, gateway module 131 can either intercept an ARP query for anycast IP address 150 and generate an ARP response with uniform MAC address 162, or intercept an ARP response from gateway 110 and swap the gateway MAC address with uniform MAC address 162 in the ARP response.

In some embodiments, gateway modules 131 and 141 maintain a mapping between IP address 150 and corresponding MAC addresses 162 and 164 for VXLAN 1 and VXLAN 2, respectively. For example, based on the mapping, if gateway module 131 intercepts an ARP query for IP address 150 from virtual machine 132, gateway module 131 obtains uniform MAC address 162 associated with VXLAN 1 and generates an ARP response comprising MAC address 162 as the MAC address corresponding to IP address 150. On the other hand, if gateway module 131 intercepts an ARP query for IP address 150 from virtual machine 138, gateway module 131 obtains uniform MAC address 164 associated with VXLAN 2 and generates an ARP response comprising MAC address 164 as the MAC address corresponding to IP address 150. In this way, the same IP address 150 can be mapped to different MAC addresses 162 and 164 for different VXLANs. As a result, virtual machines belonging to different VXLANs can use the same IP address as the default gateway IP address. The separate uniform MAC address mapping allows a packet to be forwarded within a VXLAN while maintaining tenant separation in shared resources.

Upon receiving the ARP response from gateway module 131, virtual machine 132 considers MAC address 162 as the MAC address of gateway 110, maps MAC address 162 to IP address 150, and stores the mapping in local ARP cache for subsequent communication. Virtual machine 132 then encapsulates the packet in a layer-2 header (e.g., an Ethernet header) with MAC address 162 as the destination address and provides the packet to virtualization software 130. However, because MAC address 162 is a shared address and is common to both gateways 110 and 120, MAC address 162 cannot be used to forward the packet in layer-2 segment 172. To solve this problem, gateway module 131 intercepts the packet and checks the destination address in the layer-2 header. When gateway module 131 detects uniform MAC address 162 as the destination address, gateway module 131 swaps uniform MAC address 162 with gateway MAC address of gateway 110 (i.e., the corresponding gateway of layer-2 segment 172). Because the gateway MAC address uniquely identifies gateway 110 in layer-2 segment 172, the packet can now reach gateway 110. Upon receiving the packet, gateway 110 forwards the packet based on its upper-layer destination address (e.g., an IP address).

Because MAC address 162 uniformly corresponds to gateways 110 and 120, virtual machine 132 can use MAC address 162 to access a gateway even after a migration. FIG. 1B illustrates virtual machine migration in extended virtualized layer-2 networks with uniform gateway access in conjunction with the example in FIG. 1A. During operation, virtual machine 132 migrates to host machine 122 in layer-2 segment 174 of VXLAN 1 (denoted with dotted lines) and starts running on virtualization software 140. In some embodiments, virtualization software 130 establishes a tunnel 170 with virtualization software 140 across network 101 to facilitate the migration of virtual machine 132. Virtual machine 132 retains the ARP cache during the migration process (i.e., retains the mapping between IP address 150 and MAC address 162).

After migrating to layer-2 segment 174, to send a packet to outside of VXLAN 1, virtual machine 132 encapsulates the packet in layer-2 header with MAC address 162 as the destination address and provides the packet to virtualization software 140. Gateway module 141 in virtualization software 140 detects uniform MAC address 162 as the destination address and swaps uniform MAC address 162 with gateway MAC address of gateway 120 (i.e., the corresponding gateway of layer-2 segment 174). Because the gateway MAC address uniquely identifies gateway 120 in layer-2 segment 174, the packet can now reach gateway 120. Upon receiving the packet, gateway 120 forwards the packet based on its upper-layer destination address.

Similar to virtual machine 132, virtual machine 144 migrates to host machine 112 in layer-2 segment 172 of VXLAN 2 (denoted with dotted lines) and starts running on virtualization software 130. Suppose that virtual machine 144 has obtained uniform MAC address 164 as the MAC address corresponding to anycast IP address 150. During the migration process, virtual machine 144 retains the ARP cache during the migration process (i.e., retains the mapping between IP address 150 and MAC address 164). After migrating to layer-2 segment 172, to send a packet to outside of VXLAN 2, virtual machine 144 encapsulates the packet in layer-2 header with MAC address 164 as the destination address and provides the packet to virtualization software 130. Gateway module 131 in virtualization software 130 detects uniform MAC address 164 as the destination address and swaps uniform MAC address 164 with gateway MAC address of gateway 110. Because the gateway MAC address uniquely identifies gateway 110 in layer-2 segment 172, the packet now can reach gateway 110. Upon receiving the packet, gateway 110 forwards the packet based on its upper-layer destination address. In this way, the uniform gateway access not only allows a virtual machine to migrate while retaining its gateway configuration and ARP cache, it also dynamically selects the corresponding gateway in a layer-2 segment.

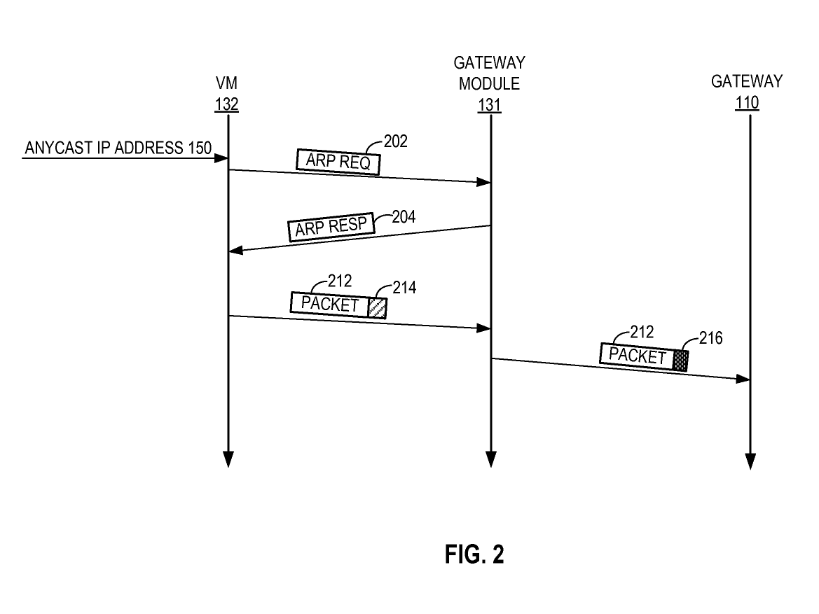

FIG. 2 presents a time-space diagram illustrating an exemplary communication process of facilitating uniform gateway access. During operation, virtual machine 132 is configured with anycast IP address 150 as the default gateway address. If virtual machine 132 does not know the MAC address corresponding to IP address 150, virtual machine 132 sends an ARP request 202 for IP address 150. Because virtual machine 132 runs on virtualization software 130, virtual machine 132 provides ARP request 202 to virtualization software 130. Gateway module 131 of virtualization software 130 intercepts ARP request 202, detects ARP request 202 to be for anycast IP address 150, and identifies that virtual machine 132 belongs to VXLAN 1. Gateway module 131 then obtains uniform MAC address 162 associated with VXLAN 1, generates ARP response 204 comprising MAC address 162 as the MAC address corresponding to IP address 150, and provides ARP response 204 to virtual machine 132.

When virtual machine 132 generates a packet 212 destined to outside of VXLAN 1, virtual machine 132 encapsulates packet 212 in layer-2 header 214 with MAC address 162 as the destination address and provides packet 212 to virtualization software 130. Gateway module 131 intercepts packet 212 and identifies uniform MAC address 162 in layer-2 header 214 to be associated with gateway 110. Gateway module 131 modifies layer-2 header 214 to create layer-2 header 216 encapsulating packet 212 by swapping uniform MAC address 162 with gateway MAC address of gateway 110 as the destination address. Because the gateway MAC address uniquely identifies gateway 110 in layer-2 segment 172, packet 212 with layer-2 header 216, which comprises gateway MAC address as the layer-2 destination address, reaches gateway 110.

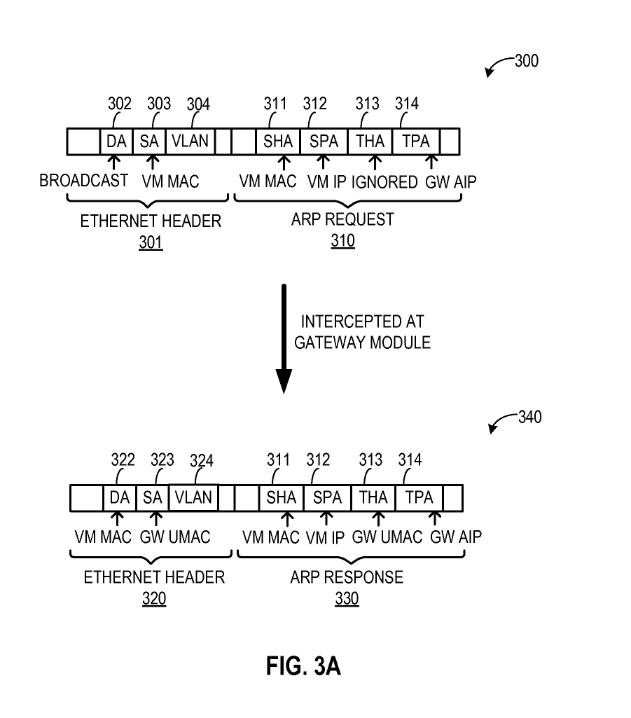

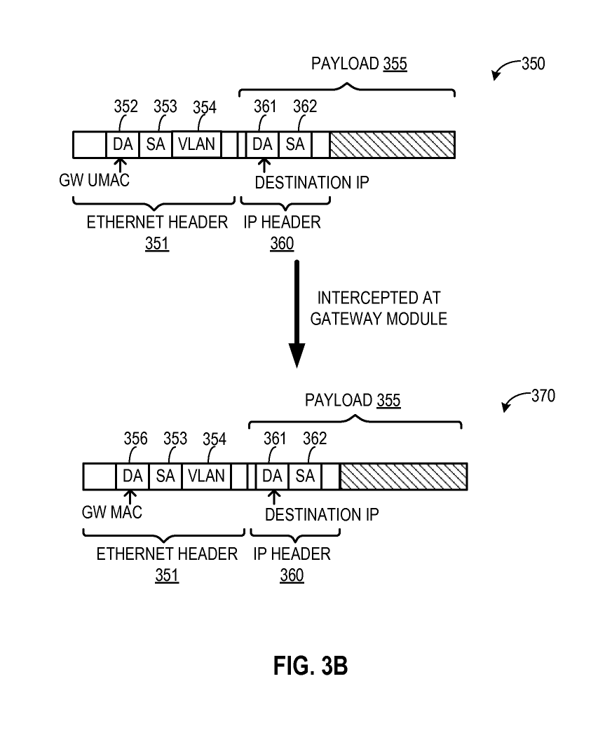

FIG. 3A illustrates an exemplary format for an Address Resolution Protocol (ARP) query and its response frames for facilitating uniform gateway access. ARP query 300 typically includes an Ethernet header 301 and an ARP request 310. Ethernet header 301 includes a MAC destination address (DA) 302, a MAC source address (SA) 303, and optionally a VLAN tag 304. ARP request 310 can include a sender hardware address (SHA) 311, a sender protocol address (SPA) 312, a target hardware address (THA) 313, and a target protocol address (TPA) 314. In ARP query 300, a hardware address typically refers to a MAC address and a protocol address typically refers to an IP address.

Suppose that ARP query is 300 generated by virtual machine 132 for obtaining the MAC address of gateway 110. While creating ARP request 310, virtual machine 132 assigns the MAC address of virtual machine 132 as SHA 311 and the IP address of virtual machine 132 as SPA 312. Virtual machine 132 assigns anycast IP address 150 of gateway 110 as TPA 314. Because ARP query 300 is generated for obtaining the MAC address corresponding to anycast IP address 150, THA 313 field is ignored in ARP request 310. Virtual machine 132 then encapsulates ARP request 310 in Ethernet header 301 and assigns the MAC address of virtual machine 132 as the MAC SA 303. Virtual machine 132 indicates VXLAN 1 in VLAN tag 304 and assigns a layer-2 broadcast address to MAC DA 302, ensuring ARP query 300 reaches all devices in VXLAN 1.

In some embodiments, gateway module 131 intercepts APR query 300 and generates an ARP query response 340 for virtual machine 132 on behalf of gateway 110. ARP query response 340 includes an Ethernet header 320 and an ARP response 330. Ethernet header 320 includes a MAC DA 322, a MAC SA 323, and optionally a VLAN tag 324. ARP response 330 includes SHA 311, SPA 312, THA 313, and TPA 314. While creating ARP response 330, gateway module 131 retains the same SHA 311 and SPA 312 of ARP request 310 (i.e., the MAC and IP addresses of virtual machine 132 as SHA 311 and SPA 312, respectively). Gateway module 131 also retains the same TPA 314 of ARP request 310 (i.e., anycast IP address 150).

Gateway module 131 identifies virtual machine 132 to be associated with VXLAN 1 based on VLAN tag 304 and obtains the corresponding uniform MAC address 162. Because ARP response 320 is generated for providing THA 313, gateway module 131 assigns uniform MAC address 162 as THA 313 of ARP response 330. Virtual machine 132 then encapsulates ARP response 330 in Ethernet header 320 and assigns the MAC address virtual machine 132 as the MAC DA 302. Gateway module 131 indicates VXLAN 1 in VLAN tag 304 and assigns uniform MAC address 162 to MAC SA 303. In this way, gateway module 131 ensures that virtual machine 132 perceives ARP query response 340 to be from gateway 110 and precludes virtual machine 131 from learning the gateway MAC address of gateway 110.

FIG. 3B illustrates an exemplary format for a conventional layer-2 frame destined to a gateway and its modified header for facilitating uniform gateway access. In this example, the conventional layer-2 frame is an Ethernet frame 350, which typically includes an Ethernet header 351 and a payload 355. Typically, payload 355 can include an IP packet, which includes an IP header 360. Ethernet header 351 includes a MAC DA 352, a MAC SA 353, and optionally a VLAN tag 354. IP header 360 includes an IP DA 361 and an IP SA 362.

Suppose that virtual machine 131 generates the IP packet destined to outside of VXLAN 1. Virtual machine 131 then assigns the IP address of the destination to IP DA 361 and the IP address of virtual machine 131 to IP SA 362. Virtual machine 132 encapsulates the IP packet in Ethernet header 351 and includes the IP packet in payload 355. Virtual machine 132 assigns the MAC address of virtual machine 132 as the MAC SA 353 and indicates VXLAN 1 in VLAN tag 354. Because the IP packet is destined to outside of VXLAN 1, virtual machine 132 needs to send frame 350 to gateway 110. Hence, virtual machine 132 assigns uniform MAC address 162 of gateway 110 to MAC DA 352.

However, because MAC address 162 is a shared address and is common to both gateways 110 and 120, MAC address 162 cannot be used to forward frame 350 in VXLAN 1. In some embodiments, gateway module 131 intercepts frame 350 from virtual machine 132 and identifies uniform MAC address 162 to be associated with corresponding gateway 110. Gateway module 131 then swaps MAC address 162 with the gateway MAC address of gateway 110, thereby modifying Ethernet header 351 to generate modified Ethernet frame 370. Gateway module 131 sends this modified frame 370 to gateway 110. Because the gateway MAC address in MAC DA 356 uniquely identifies gateway 110 in VXLAN 1, frame 370 can now reach gateway 110.

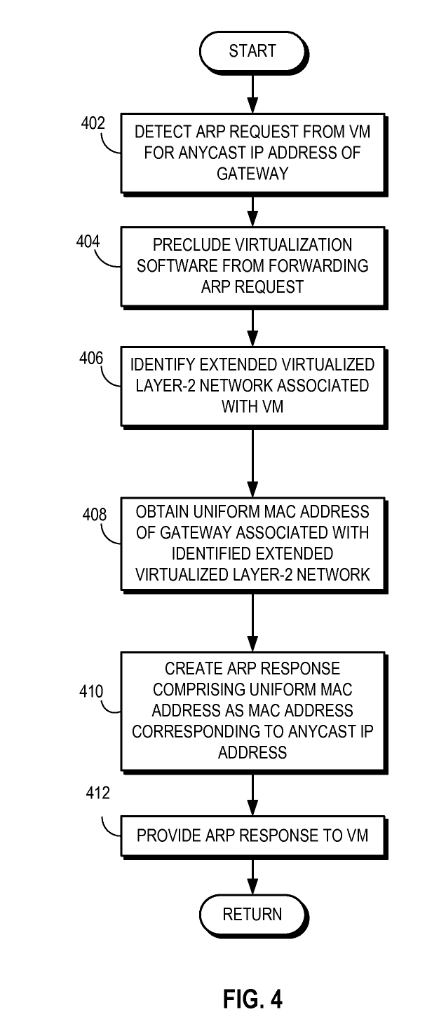

FIG. 4 presents a flow chart illustrating an exemplary process of a gateway module intercepting and responding to an ARP request for facilitating uniform gateway access. During operation, the gateway module detects an ARP request for an anycast IP address of a gateway from a virtual machine (operation 402). Note that the virtualization software on which the virtual machine runs includes the gateway module. Typically, the virtualization software broadcasts the ARP request in the layer-2 network to which the virtual machine belongs. However, based on the detection, the gateway module precludes the virtualization software from forwarding the ARP request (operation 404).

The gateway module then identifies the extended virtualized layer-2 network associated with the virtual machine (operation 406). An example of an extended virtualized layer-2 network is a VXLAN. The gateway module obtains a uniform MAC address of the gateway associated with the identified extended virtualized layer-2 network (operation 408). This gateway typically is in the same layer-2 segment to which the host of the virtualization software included. In some embodiments, the gateway can have a respective uniform MAC address for a respective extended virtualized layer-2 network and ensures uniform access to the gateway from any extended virtualized layer-2 network. The gateway module then creates an ARP response comprising the uniform MAC address as the MAC address corresponding to the unicast IP address (operation 410) and provides the ARP response to the virtual machine (operation 412), as described in conjunction with FIG. 3A.

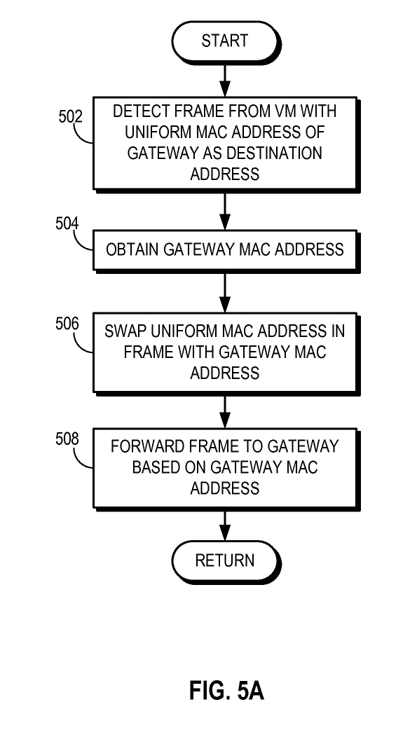

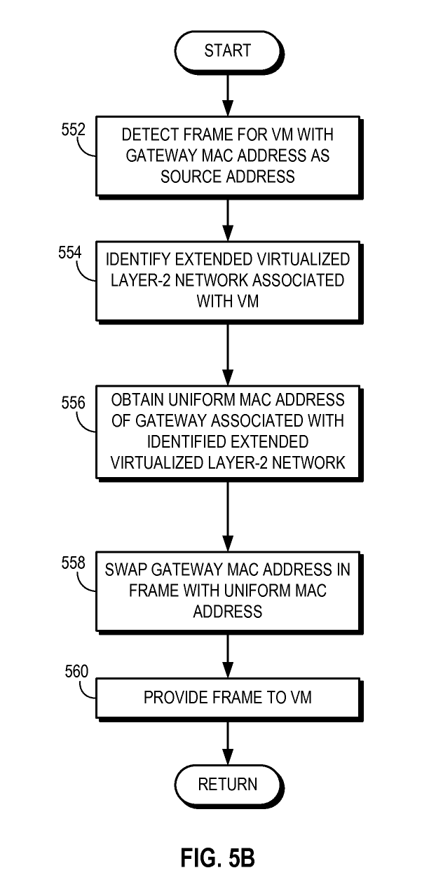

FIG. 5A presents a flow chart illustrating an exemplary process of a gateway module swapping MAC address of a frame from a virtual machine to a gateway. During operation, the gateway module detects a frame from a virtual machine with a uniform MAC address of the gateway as the destination address (operation 502). Because the uniform MAC address is a shared address and is common to all gateways in an extended virtualized layer-2 network, the uniform MAC address cannot be used to forward the frame to the gateway. The gateway module obtains the gateway MAC address for the gateway (i.e., the MAC address using which the gateway is reachable) (operation 504) and swaps the uniform MAC address in the frame with the gateway MAC address (operation 506), as described in conjunction with FIG. 3B. The gateway module then forwards the frame to the gateway based on the gateway MAC address (operation 508).

FIG. 5B presents a flow chart illustrating an exemplary process of a gateway module swapping MAC address of a frame to a virtual machine from a gateway. During operation, the gateway module detects a frame, which indicates the gateway MAC address as the source address, destined to a virtual machine (operation 552). Note that the virtualization software on which the virtual machine runs includes the gateway module. The gateway module then identifies the extended virtualized layer-2 network associated with the virtual machine (operation 554). An example of an extended virtualized layer-2 network is a VXLAN. The gateway module obtains a uniform MAC address of the gateway associated with the identified extended virtualized layer-2 network (operation 556). The gateway module then swaps the gateway MAC address with the uniform MAC address as the source address of the frame (operation 558) and provides the frame to the virtual machine (operation 560).

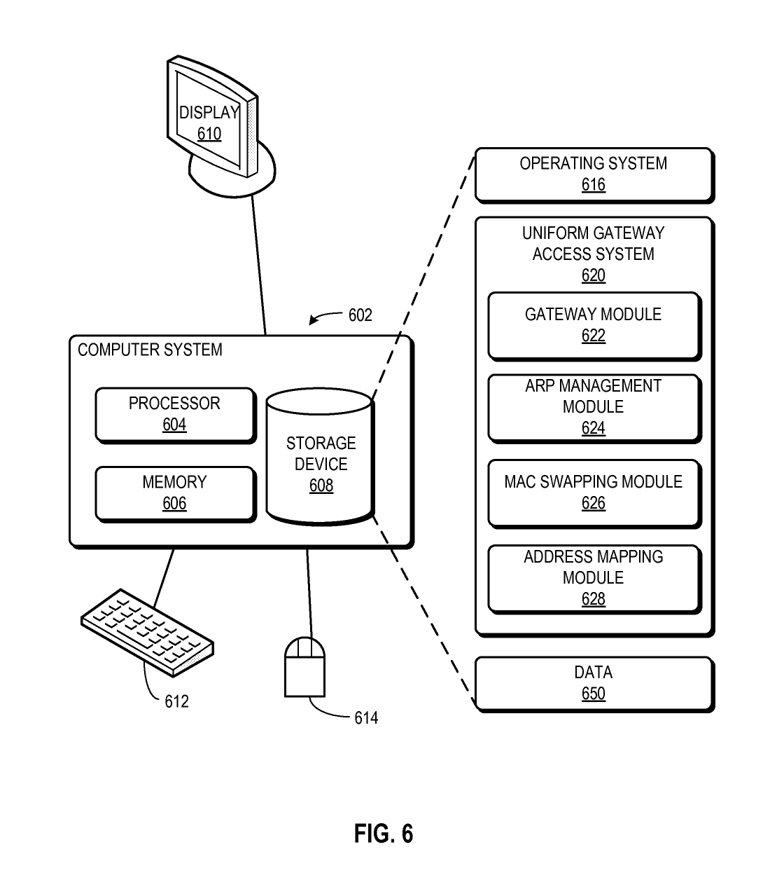

It should be noted that the gateway module described herein can be implemented as a stand-alone appliance, as part of a switch or router, or as part of a host machine. Furthermore, the gateway module can be implemented in hardware or software, or a combination of both. FIG. 6 illustrates an exemplary computing system with uniform gateway access support. In this example, a computer system 602 includes a processor 604, memory 606, and a storage device 608. Computer system 602 is also coupled to a display 610, a keyboard 612, and a pointing device 614. Storage device 608 stores data 650 and instructions which when loaded into memory 606 and executed by processor 604 implement an operating system 616, and a uniform gateway access system 620. Uniform gateway access system 620 includes a gateway module 622, an ARP management module 624, a MAC swapping module 626, and an address mapping module 628. When executed by the processor, these modules jointly or separately perform the functions described above.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for providing uniform access to a gateway in an extended virtualized layer-2 network, comprising:
identifying a first media access control (MAC) address in a layer-2 header of a data frame, wherein the first MAC address is associated with a respective gateway in the extended virtualized layer-2 network;
modifying the layer-2 header by swapping the first MAC address with a second MAC address in the layer-2 header, wherein the second MAC address uniquely identifies a gateway in the extended virtualized layer-2 network; and
forwarding the frame with the modified header to the gateway based on the second MAC address.

2. The computer-implemented method of claim 1, wherein the first MAC address is specific to the extended virtualized layer-2 network; and
wherein the first MAC address is not associated with a second extended virtualized layer-2 network.

3. The computer-implemented method of claim 1, wherein the first MAC address corresponds to an Internet Protocol (IP) address, and wherein the IP address is associated with a respective gateway and is uniform in the extended virtualized layer-2 network.

4. The computer-implemented method of claim 3, further comprising maintaining a mapping between the first MAC address and the IP address.

5. The computer-implemented method of claim 4, wherein the mapping is maintained by a virtual machine; and
wherein the method further comprises retaining the mapping during migration of the virtual machine.

6. The computer-implemented method of claim 5, in response to the migration of the virtual machine, further comprising:
modifying the layer-2 header by swapping the first MAC address with a third MAC address in the layer-2 header, wherein the third MAC address uniquely identifies a second gateway in the extended virtualized layer-2 network; and
forwarding the frame with the modified header to the second gateway based on the third MAC address.

7. The computer-implemented method of claim 3, further comprising:
identifying an address resolution query from a virtual machine for the IP address, wherein the virtual machine is associated with a virtualization software;
generating by the virtualization software an address resolution response indicating a correspondence between the first MAC address and the IP address; and
providing the generated address resolution response to the virtual machine.

8. The computer-implemented method of claim 7, further comprising:
identifying an address resolution query from a second virtual machine for the IP address, wherein the second virtual machine is associated with a second extended virtualized layer-2 network;
generating by the virtualization software an address resolution response indicating a correspondence between a third MAC address and the IP address, wherein the third MAC address is associated with a respective gateway in the second extended virtualized layer-2 network; and
providing the generated address resolution response to the second virtual machine.

9. The computer-implemented method of claim 7, further comprising precluding the virtualization software from forwarding the address resolution query to a gateway associated with the IP address

10. The computer-implemented method of claim 1, wherein the extended virtualized layer-2 network is implemented based on one or more of:
a Virtual Extensible Local Area Network (VXLAN);
a Stateless Transport Tunnels (STT);
a Multi-Protocol Label Switching (MPLS) protocol; and
a Generic Routing Encapsulation (GRE) protocol.

11. A non-transitory storage medium storing instructions which when executed by a processor cause the processor to perform a method for providing uniform access to a gateway in an extended virtualized layer-2 network, the method comprising:
identifying a first media access control (MAC) address in a layer-2 header of a data frame, wherein the first MAC address is associated with a respective gateway in the extended virtualized layer-2 network;
modifying the layer-2 header by swapping the first MAC address with a second MAC address in the layer-2 header, wherein the second MAC address uniquely identifies a gateway in the extended virtualized layer-2 network; and
forwarding the frame with the modified header to the gateway based on the second MAC address.

12. The non-transitory storage medium of claim 11, wherein the first MAC address is specific to the extended virtualized layer-2 network; and
wherein the first MAC address is not associated with a second extended virtualized layer2 network.

13. The non-transitory storage medium of claim 11, wherein the first MAC address corresponds to an Internet Protocol (IP) address, and wherein the IP address is associated with a respective gateway and is uniform in the extended virtualized layer-2 network.

14. The non-transitory storage medium of claim 13, wherein the method further comprises maintaining a mapping between the first MAC address and the IP address.

15. The non-transitory storage medium of claim 14, wherein the mapping is maintained by a virtual machine; and
wherein the method further comprises retaining the mapping during migration of the virtual machine.

16. The non-transitory storage medium of claim 15, wherein, in response to the migration of the virtual machine, the method further comprises:
modifying the layer-2 header by swapping the first MAC address with a third MAC address in the layer-2 header, wherein the third MAC address uniquely identifies a second gateway in the extended virtualized layer-2 network; and
forwarding the frame with the modified header to the second gateway based on the third MAC address.

17. The non-transitory storage medium of claim 13, the method further comprises:
identifying an address resolution query from a virtual machine for the IP address, wherein the virtual machine is associated with a virtualization software;
generating by the virtualization software an address resolution response indicating a correspondence between the first MAC address and the IP address; and
providing the generated address resolution response to the virtual machine.

18. The non-transitory storage medium of claim 17, the method further comprises:
identifying an address resolution query from a second virtual machine for the IP address, wherein the second virtual machine is associated with a second extended virtualized layer-2 network;
generating by the virtualization software an address resolution response indicating a correspondence between a third MAC address and the IP address, wherein the third MAC address is associated with a respective gateway in the second extended virtualized layer-2 network; and
providing the generated address resolution response to the second virtual machine.

19. The non-transitory storage medium of claim 17, the method further comprises precluding the virtualization software from forwarding the address resolution query to a gateway associated with the IP address

20. The non-transitory storage medium of claim 11, wherein the extended virtualized layer-2 network is implemented based on one or more of:
a Virtual Extensible Local Area Network (VXLAN);
a Stateless Transport Tunnels (STT);
a Multi-Protocol Label Switching (MPLS) protocol; and
a Generic Routing Encapsulation (GRE) protocol.

21. A computing system for providing uniform access to a gateway in an extended virtualized layer-2 network, the computing system comprising:
a processor; and
a storage device coupled to the processor and storing instructions which when executed by the processor cause the processor to perform a method, the method comprising:
identifying a first media access control (MAC) address in a layer-2 header of a data frame, wherein the first MAC address is associated with a respective gateway in the extended virtualized layer-2 network;
modifying the layer-2 header by swapping the first MAC address with a second MAC address in the layer-2 header, wherein the second MAC address uniquely identifies a gateway in the extended virtualized layer-2 network; and
forwarding the frame with the modified header to the gateway based on the second MAC address.
